(19) United States
(12) Patent Application Publication
(10) Pub. No.: US 2006/0003058 A1
(43) Pub. Date: Jan. 5, 2006

(54) Multilayered, tub-shaped food barrier wrappers having transfer properties

(76) Inventors: Martina Koenig, Wiesbaden (DE); Bernhard Feron, Wiesbaden (DE); Hans-Gerhard Fritz, Uhingen (DE)

Correspondence Address: Klaus Schweitzer;ProPat, 425 C South Sharon Amity Road, Charlotte, NC, 28212-1413, US

(21) Appl. No.: 10/526,453

(22) PCT Filed: Sep. 22, 2003
(86) PCT No.: PCT/EP03/10500

§ 371 Date: Mar. 2, 2005

(30) Foreign Application Priority Data
Sep. 23, 2002 (DE) 102 44 088.3

(51) Int. Cl. A23G 1/00

(52) U.S. Cl. 426/135

(57) ABSTRACT

A tube-shaped food wrapper is disclosed, particularly a sausage wrapper, comprising at least two layers. The inner layer facing the food is provided with a matrix made of an organic, thermoplastic polymer material and a powdered organic filler which is embedded therein and contains a food additive that can be transferred to the filling material. The organic filler preferably consists of a carrageenan powder while the food additive preferably consists of a liquid smoke. At least one additional layer has barrier properties, i.e. is provided with a reduced permeability to water vapor and/or atmospheric oxygen. Layers based on polyolefin or polyamide are particularly suitable for the addtional layer(s).

The invention relates to a tubular food casing with barrier action for oxygen and water vapor, which has two or more layers and is capable of absorbing a food additive and storing it and dissipating it into the contents.

Food casings of the type mentioned are known in principle. Examples of these are packaging films for meat products, sausage products, or fish products, with a dye and starch or a starch derivative as dye substrate. On heating, at least some of the dye then transfers to the food (DE 296 00 547 U1). Another known packaging film for foods has, on the side facing toward the food, a layer comprising a flavor component or fragrance component and a polysaccharide or protein as binder (WO 98/31731; EP-A 986 957). The substrate layer of the film here is composed of polyolefin, polyester, polyvinylidene chloride (PVDC), polyvinyl chloride (PVC), or polystyrene.

JP-A 139401/2000 discloses a film which can be used to transfer food coloring to sausage emulsion, ham, or similar foods. For this, the film has a coating which comprises not only a food dye but also an edible plasticizer, such as glycerol, sorbitol, or propylene glycol.

Finally, DE 198 46 305 A1 discloses a barrier film composed of plastics material which encompasses layers based on polyamide and also on polyolefin, and, on the inner side, has been bonded to a layer composed of a woven or knitted, absorbent material saturated with dyes or with flavorings. On cooking or scalding, these materials are transferred from the inner layer to the food. The absorbent inner layer here has adhesive-bonding to the plastics barrier casing. Tubular casings can be produced from the film via hot-sealing or adhesive bonding.

DE 102 17 132, which is not a prior publication, discloses a double food casing, i.e. a casing which encompasses two mutually superposed casings bonded to one another mechanically only in their respective foremost region. The outer casing here in essence assumes the barrier function and also gives the entire structure most of its mechanical stability, while the inner casing serves as intermediate substrate for a food additive.

The known tubular casings with a transferable food additive have various disadvantages. They either require very complicated production processes (e.g. for the casing with the inner layer composed of an absorbent material), or cannot store and transfer the desired amount of the food additive.

There continues therefore to be an object of providing a food casing, preferably a sausage casing, which has particularly low permeability to oxygen and water vapor. It is to protect the contents dependably from penetration of microbes and fungi. Furthermore, it is to be capable of absorbing a particularly effective amount of a food additive, in particular a colorant, odorant, flavoring, and/or decorative material, and of storing this material and dissipating it, after stuffing and in the course of a physical and/or thermal post-treatment (e.g. scalding, cooking, or steaming) to the surface and/or to the bulk of the contents (e.g. emulsion, sausage mixture, meat mixture). The food casing is moreover to be capable of more cost-effective and more reliable production and processing, ideally in continuous processes.

The object is achieved via an inner layer which encompasses a matrix composed of a thermoplastic material and which encompasses an organic filler distributed therein.

The present invention therefore provides an at least two-layer, tubular food casing with barrier action for oxygen and water vapor, which is capable of absorbing a food additive and storing it, and dissipating it into the food, wherein the inner layer facing toward the food encompasses a matrix composed of an organic thermoplastic polymer material and encompasses, embedded therein, at least one pulverulent organic filler which comprises at least one food additive transferable to the contents. The transferable food additive here is in particular a colorant, odorant, flavoring, and/or decorative medium.

The organic filler swells in the temperature range from above 0 to below 40° C. on exposure to fluid systems (e.g. aqueous systems, aqueous solutions or suspensions, or other low-viscosity fluids), with initial enlargement of its volume. It thus absorbs the transferable food additive and stores it. Once a material has been filled with the food, it dissolves at least to some extent on exposure to moisture, water vapor or other fluids on heating to a temperature in the range from above 40 to below 100° C., and transfers the stored additives to the food. Particularly suitable fillers are natural materials, such as carrageenan, agar, soybean proteins, ground carob bean, native, destructured, and/or modified starches, and also mixtures of the abovementioned substances. By way of example, the organic filler can be incorporated into a thermoplastic melt by mixing during a compounding process using a corotating, closely intermeshing twin-screw extruder.

The particle size to be selected for the filler (prior to addition of the transferable food additive) depends mainly on the thickness of the filler-substrate layer to be produced. For layer thicknesses SF in the range from 60 to 100 μm it should have a d(0.5) value of less than 20 μm, and this can generally be achieved via filler fractionation. For layer thicknesses in the range from 100 to 200 μm, the d(0.5) value can certainly rise to 50 μm. Depending on the type of material, the shape of the individual filler particles here can vary from spherical to lamellar, ellipsoid, acicular, or else irregular. The proportion of the filler is advantageously up to 60%, preferably from 15 to 45% by weight, particularly preferably from 25 to 35% by weight, based in each case on the weight of the inner layer.

The transferable food additive is preferably liquid under standard industrial conditions. Liquid smoke is particularly preferred. This may be a natural (i.e. an acidic), a substantially neutral, or an alkalinified liquid smoke. Where appropriate, the liquid smoke has been freed from tar constituents, and/or comprises additives, in particular viscosity-increasing additives. A particular additive which may be mentioned is shellac, specifically flake shellac. Suitable grades of liquid smoke are commercially available. Other suitable liquids are solutions, specifically aqueous solutions of food dyes. Liquid grilled-chicken flavoring and similar liquid flavorings can also be used.

The proportion of the transferable food additive is generally from about 5 to 150% by weight, preferably from about 30 to 80% by weight, based in each case on the weight of the particulate filler.

The following requirements are placed upon the thermoplastic matrix to be used for the inner layer of the tubular film:
water vapor permeation coefficient P_{H20} in the range from 3 to 20 g/m² d;
physiologically non-hazardous;
temperature for treatment and processing of the thermoplastic is in the range from 90 to 180° C., preferably from 110 to 150° C.;
crystallite melting point or flow point of the thermoplastic is from about 80 to 110° C.

Taking into account all of these criteria, ethylene-vinyl acetate copolymer (EVA) has proven to be a particularly suitable matrix material for the inner layer of the tubular film. However, it is also possible to consider other thermoplastics which comply with the criteria formulated above. Among the ethylene-vinyl acetate copolymers (EVA), preference is given to grades whose vinyl acetate content (VA content) is from 5 to 50% by weight, in particular from 15 to 40% by weight. As VA content increases, the permeation coefficient P_{H20} for water vapor increases more than proportionally, and this proves to be advantageous for the behavior of the system. On the other hand, as VA content increases the crystallite melting point falls, and this is disadvantageous for the intended application. The result of these negatively correlated properties is that particularly suitable EVA grades prove to be those whose VA content is, for example, from 18 to 34% by weight. Mixtures of EVA grades with VA contents of 18 and 34% by weight may also be used as thermoplastic matrices, and there should be an excess here of the EVA grade with the smaller VA content. Use of EVA grades with VA contents of more than 34% by weight is also possible in principle and is described at a later stage below.

In order to provide good adhesion between the inner layer modified with organic fillers and the other polymeric functional layer adjoining in a radial direction, it has proven advantageous to admix what is known as a compatibilizer with the polymer matrix during the compounding step. This type of compatibilizer, generated in a separate treatment step, may, by way of example, be composed of the inner-layer-matrix material onto which from 0.1 to 10% by weight, preferably from 0.3 to 5% by weight, of maleic anhydride or an alternate compatibilizer molecule (such as glycidyl methacrylate, GMA) have been grafted, after initiation by peroxide radicals.

If the intention is to use ethylene-vinyl acetate copolymers (EVA) with vinyl acetate contents of more than 34% by weight, these having high values for the water vapor permeation coefficient, this intention is initially hindered by the lowered crystallite melting points (less than 80° C.). For example, an EVA grade with VA content of 40% by weight has a crystallite melting point Tₘ of 50° C. This problem can be solved by grafting organosilane molecules (e.g. vinyltrimethoxysilane or vinyltriethoxysilane) onto the inner-layer-matrix material (e.g. EVA) in an upstream compounding step, after EVA-chain activation by peroxide radicals. After extrusion of the grafted inner-layer material in the thermoplastic state, silanol formation takes place during a hydrolysis reaction on exposure to water molecules. A subsequent condensation reaction leads to crosslinking of the matrix material in the solid state. Associated with this is formation of a three-dimensional, covalently linked spatial network, and therefore these elastomers can even be exposed to temperatures which are markedly above the melting point Tₘ of the EVA grade used as starting material, without any flow of the polymeric material. This behavior of the material results from the vulcanization step mentioned.

In the simplest case, the colorant, odorant, flavoring, and/or decorative media present in liquid or aqueous form can be applied to that surface of the tube inner layer that comes into contact with the contents. These fluids, suspensions, or emulsions are absorbed and stored by the filler particles with simultaneous swelling of the same.

Once the food casings have been stuffed with emulsion, sausage mixture, or meat mixture, the organic filler which comprises the stored colorant, odorant, flavoring, and/or decorative media dissolves at least partially—this process being initiated via a scalding or steaming process—and transfers it stored materials to the surface of the contents.

Surprisingly, it has been found that the filler particle size leads to exceptionally uniform transfer. A particularly advantageous factor has proven to be that the physical/thermal post-treatment does not lead to any formation of gel deposit between inner-layer surface and contents surface.

An alternate solution, preferred on economic and process-technology grounds, for integrating the at least one transferable food additive into the respective organic filler of the tube inner layer is the following:

A weighed-out amount of the pulverulent organic filler is placed in an internal mixer. Rotation of the mixing blade of the mixer fluidizes the powder bed. A metering pump is used to introduce the liquid colorant, odorant, flavoring, and/or decorative medium, by slow metering, into the filler powder until a prescribed concentration, based on the organic filler, has been reached. The dynamic mixing procedure causes the liquid additive to be absorbed by the filler without clumping of the filler powder, even at high liquid concentrations. The amounts of liquid added may, depending on the structure of the concentrate, be from 5 to 150% by weight, preferably from 30 to 80% by weight, based in each case on the weight of filler. These circumstances permit precise gravimetric metering of the filler charge into the twin-screw extruder in which the filler is homogeneously incorporated by mixing into the thermoplastic matrix. The result is a filled thermoplastic system, pre-loaded with the additives, which can be directly further processed in a coextrusion plant to give the tube inner layer.

The inner layer comprising the organic fillers has been securely bonded to a second layer of the tube film, the latter preferably being a layer based on polyolefin(s) and acting as a barrier layer with respect to water vapor. Particularly suitable polyolefins are polyethylenes (specifically HDPE, LDPE, LLDPE) and polypropylene homo- and copolymers. Ethylene-octene and ethylene-hexene copolymers may moreover also be used.

In order to bring about secure layer adhesion between polyolefin outer layer and coextrudate inner layer, it is also advisable to add a compatibilizer. This is a polyolefin of the same generic type which has been grafted with from 0.3 to 5% of MAH and is added in amounts of from 1 to 10%, based on the polyolefin base material.

In principle, it is also possible to graft the entire polyolefin used for the H₂O-barrier layer during an upstream reactive functionalization step, using from 0.2 to 3% of MAH or equivalent coupling molecules (e.g. GMA).

For the oxygen-barrier layer which can be realized as a third layer, it is advisable to use a layer based on polyamides. Because melt temperatures have to be kept within upper limits, preference is given to copolyamides (PA6/PA6.6) or PA12 grades. The MAH molecules grafted onto the polyolefin layer may bond covalently to the amino end groups of the polyamide, thus giving strong layer adhesion which is further increased by additional hydrogen bonding.

A layered composite with PA/PO/PA structure may also be used as supportive and barrier layer composite for the inner layer enriched with organic fillers. Another way of achieving the desired barrier properties and supportive properties and of restricting the number of layers is provided by barrier-layer technology. This concept admixes specific polyamide pellets with a polyethylene or polypropylene and these are extended during laminar shear-flow processes to give very thin layers and embedded in the form of overlapping barrier lamellae into the PO matrix. These labyrinth structures markedly improve barrier properties. Compliance with certain important basic requirements in relation to materials selection and formulation is required in order to form securely adhering PA barrier layers and to ensure that the labyrinth concept is functional, and these can be outlined as follows:

The flow temperature of the low-crystallinity polyamide to be used as barrier material is to be slightly below the extrusion temperature (which is generally from 200 to 215° C.) for the respective polyolefin. Examples of polyamides with this type of flow temperature are PA 6/66 copolyamides.

In order to increase the level of interaction between barrier layer and matrix layer and therefore to form securely adhering layer structures, it has proven advantageous to use a compatibilizer which has affinity for the polymers in both adjacent layers. By way of example, a suitable compatibilizer can be prepared by using maleic anhydride (MAH) to functionalize a polyolefin used in the matrix. Activation of the polyolefin via peroxide radicals, and then grafting of maleic anhydride onto the chain radicals, produces a compatibilizer which undergoes covalent bonding to the amino end groups of the PA copolymers and thus significantly increases the compatibility and adhesion of the two polymer components.

Multilayer film tubes of the type described above can be produced advantageously using a tube-film coextrusion process known per se to the person skilled in the art. However, because the inner layer has to be extruded using melt temperatures which are relatively low (e.g. T_{M}=130-140° C.) when comparison is made with the PO and PA layer, thermal insulation is absolutely necessary within the coextrusion die used.

Under these circumstances, coextrusion dies which have proven particularly advantageous are those with lamellar spiral distributor systems, and thermal insulation plates also have to be inserted between the individual lamellar spiral distributor plates here. The advantage of this type of design, when compared with conventional spiral distributor systems cut onto cylindrical mandrels is that each distributor system can be given a discrete temperature profile matched to the respective plastic. Combined with additional mandrel temperature-control, this thus permits ideal thermal conduct of the process.

The tubular food casing of the present invention is particularly suitable as synthetic sausage-casing.

The examples below illustrate the invention. Percentages therein are percentages by weight unless otherwise stated or apparent from the context.

### EXAMPLE 1

The inner-layer-matrix material used comprised an ethylene-vinyl acetate copolymer (EVA), ®EVATANE 28-03 from ATOChem with VA content of 28%. A twin-screw extruder was used to compound unfractionated carrageenan powder into this material at a treatment temperature of 120° C., using a Berstoff ZE 25 twin-screw extruder. The proportion by weight of EVA was 70%, and that of the filler was 30%. 5% of a compatibilizer, ®Fusabond MC 190D (EVA grafted with 5% of MAH) from DuPont Europe were added, based on the EVA content of the compounded material. The resultant pellets were used to produce tube films with average film thickness 180 μm with the aid of a Collin blown-film plant. Liquid smoke was then manually applied to that inner surface of the tube film coming into contact with the contents. The liquid smoke was composed of
33.0% of a 4% strength aqueous NaOH solution,
8.0% of shellac,
7.0% of an alkalinified liquid smoke from Zesti Smoke,
48.9% of water,
1.0% of alginate,
1.0% of siliceous earth,
1.0% of a brown food colorant (Eurolake Brown HT), and
0.1% of citral.

It was spontaneously absorbed by the incorporated filler particles, and stored therein, with simultaneous swelling of the same.

After a storage time of from 3 to 5 days, sections of the resultant prepared tube film were stuffed with meat sausage emulsion and then scaled at 70° C. The scalding procedure led to very uniform and almost complete transfer of the liquid smoke colorant and the liquid smoke flavor to the emulsion, via partial solution of the carrageenan particles. These specimens were free from gel deposit; the casings could easily be peeled from the sausage emulsion.

### EXAMPLE 2

Example 1 was modified in that the matrix material of the inner layer was now composed of a EVA mixture composed of 45% of EVATANE 28-05 (VA content: 28%) and 55% of ELVAX 460 (VA content: 18%) from DuPont. 70% of this mixture were treated with 30% of unfractionated carrageenan powder, and the resultant mixture was compounded with addition of 5% of Fusabond MC 190 D compatibilizer (based on EVA content), with the aid of a Berstorff ZE 25 twin-screw extruder. Production of the tube film, internal preparation of sections, and stuffing of the sections took place as described in example 1. The specimens could now be scalded at 85° C., because of the rise, due to the polymer, in crystallite melting point of the matrix material to 87° C., without damage to the casing or undefined tearing on peeling. The increased scalding temperature firstly gave a reduction in the scalding time and secondly gave practically complete transfer of the colorant and flavoring to the contents, without any gel deposit.

### EXAMPLE 3

Carrageenan powder was fluidized in a Henschel internal mixer. A membrane metering pump was used to introduce 80% of liquid smoke of the type described, based on the weight of filler introduced, into the fluid mixer. The liquid smoke was absorbed spontaneously by the carrageenan powder, without clumping. The result of this preparative step was a “dry” powder which could be metered without difficulty, using gravimetric metering equipment. The filler powder treated with the liquid smoke was introduced into the ZE 25 twin-screw extruder, together with the EVA mixture described in example 2. The ratio by weight of pure carrageenan powder to EVA mixture was 30:70. In addition, 5% of ®Fusabond MC 190 D compatibilizer (based on EVA content) were again added.

Production of the tube film and stuffing of the tube sections took place as described in example 1. No preparation of the tube sections via manual application of the liquid smoke was now required, because a sufficient amount of the liquid smoke had been incorporated by this stage within the carrageenan powder compounded into the material. At a scalding temperature of 85° C., transfer of the colorant and flavoring to the contents (meat sausage emulsion) was practically complete. No gel deposit was observed. The casing could also be peeled easily without any resultant undefined tearing.

### EXAMPLE 4

Example 3 was repeated, except that the carrageenan powder prepared with liquid smoke in the fluid mixer was a fractionated powder batch whose d(0.5) value from particle size analysis was 16 μm. The reduced average particle size permitted production of tube films with lower wall thickness (100-110 μm), while the behavior of the overall system was otherwise identical.

1. An at least two-layer, tubular food casing with barrier action for oxygen and water vapor, which is capable of absorbing a food additive, storing it, and dissipating it into the food, said casing comprising an inner filler-substrate layer facing toward the food said filler-substrate layer comprising a matrix comprising an organic thermoplastic polymer material and, embedded therein, at least one pulverulent organic filler which comprises at least one food additive transferable to the contents.

2. The food casing as claimed in claim 1, wherein the food additive is a transferable colorant, odorant, flavoring, and/or decorative medium.

3. The food casing as claimed in claim 1, wherein the pulverulent organic filler absorbs and stores the transferable food additive, said filler swelling in the temperature range from 0 to 40° C. and then transferring said food additive to the food, with partial dissolution of the organic filler, at a temperature in the range from above 40 to 100° C.

4. The food casing as claimed in claim 1, wherein the pulverulent organic filler is a natural material.

5. The food casing as claimed in claims 1, wherein the particles of the pulverulent organic filler have, prior to addition of the food additive, a d(0.5) value of less than 20 μm for a filler-substrate layer thickness of from 60 to 100 μm, and a d(0.5) value less than 50 μm for a filler-substrate layer thickness of from 100 to 200 μm.

6. The food casing as claimed in claim 1, wherein the proportion of the pulverulent organic filler is up to 60% by weight, based on the weight of the inner filler-substrate layer.

7. The food casing as claimed in claim 1, wherein the proportion of the transferable food additive is from 5 to 150% by weight, based on the weight of the particulate filler.

8. The food casing as claimed in claim 1, wherein the transferable food additive is a liquid smoke.

9. The food casing as claimed in claim 1, wherein the inner filler-substrate layer of the tube film comprises a polymer matrix whose water vapor permeation coefficient P_{H20} is in the range from 3 to 20 g/m² d.

10. The food casing as claimed in claim 1, wherein the matrix comprises an ethylene-vinyl acetate copolymer.

11. The food casing as claimed in claim 10, wherein the proportion of vinyl acetate units in the ethylene-vinyl acetate copolymer is from 5 to 50% by weight.

12. The food casing as claimed in claim 9, wherein the polymer matrix has at least one admixed compatibilizer.

13. The food casing as claimed in claim 12, wherein the compatibilizer is comprised of the inner-layer matrix material onto which from 0.1 to 10% by weight of a compatibilizer molecule has been grafted, following peroxide-radical initiation.

14. The food casing as claimed in claim 13, wherein the compatibilizer is a maleic-anhydride- or glycidyl-methacrylate-grafted ethylene-vinyl acetate copolymer.

15. The food casing as claimed in claims 1, wherein a layer based on polyolefin(s) is adjacent to the filler-substrate layer and acts as barrier layer for water vapor.

16. The food casing as claimed in claims 1, further comprising at least one layer which is based on polyamide and/or copolyamide and acts as barrier layer for oxygen.

17. A sausage casing comprising a food casing as claimed in claim 1.

18. The food casing as claimed in claim 4, wherein the natural material is pulverulent carrageenan, agar, soybean protein, ground carob beans, native starch, destructured starch, modified starch, or mixtures thereof.
